(19) United States
(12) Patent Application Publication
(10) Pub. No.: US 2002/0196120 A1
(43) Pub. Date: Dec. 26, 2002

(54) Non-energy limiting class 2 transformer with positive temperature protection

(76) Inventors: Philip J. Hopkinson, Charlotte, NC (US); Alan D. Neal, Morrisville, NC (US); Keith E. Seifried, Knightdale, NC (US); Michel A. Rapeaux, Cedar Rapids, IA (US); Gary T. Jones, Antioch, TN (US)

Correspondence Address: Wallenstein & Wagner, Ltd., 311 S. Wacker Drive, 53rd Floor, Chicago, IL, 60606-6630, US

(21) Appl. No.: 10/057,317

(22) Filed: Jan. 24, 2002

Related U.S. Application Data
(63) Continuation-in-part of application No. 09/885,206, filed on Jun. 20, 2001.

(51) Int. Cl. H01F 27/24

(52) U.S. Cl. 336/212

(57) ABSTRACT

A protected transformer system and method are disclosed. The protected transformer system uses positive temperature coefficient resistive devices. The system can comprise a transformer and a positive temperature coefficient device. The transformer has a primary and a secondary winding. The secondary winding has a housing, a first terminal, a second terminal, and an insulated covering. The positive temperature coefficient device is connected to the first terminal of the secondary winding. The positive temperature coefficient device mounted in the housing. The positive temperature coefficient device has a first and second side. The first side of the positive temperature coefficient device is mounted between 0.2 mm 0.4 mm from the secondary winding. The second side of the positive temperature coefficient device is mounted between 1 mm and 5 mm from the secondary winding. The insulated covering is between the first side of the positive temperature coefficient device and the secondary winding.

### CROSS-REFERENCE TO RELATED APPLICATIONS

This application is a continuation-in-part of copending U.S. utility application entitled “Positive Temperature Coefficient Resistivity Protected Power Transformer,” having Ser. No. 09/885,206, filed Jun. 20, 2001, which is entirely incorporated herein by reference.

### TECHNICAL FIELD

The present invention is generally related to overcurrent protected transformers and, more particularly, is related to a system and method for protecting transformers from unsafe current levels using positive temperature coefficient resistive devices.

### BACKGROUND

The National Electrical Manufacturers Association (NEMA) defines non-energy limiting class 2 transformers as transformers that are provided with an overcurrent protective device that limits the transformer output current to a thermally safe maximum value. Class 2 transformers generally have power ratings of 20-75 VA with a load voltage of 24 volts. In the art, the overcurrent protective device used in class 2 transformers is a circuit breaker or a fuse. The known overcurrent protective device is placed in the secondary circuit of the transformer. The known class 2 transformers are desirably sensitive to load currents and ambient temperatures. The class 2 transformers open when a threshold temperature is exceeded. Class 2 transformers are commonly used in applications such as, but not limited to, air conditioning systems, heating systems, and equipment control circuits.

Positive temperature coefficient devices, such as polymer positive temperature coefficient resistive circuit protection devices (PPTCs), are well known. The PPTC is placed in series with a load, and under normal operating conditions is in a low temperature, low resistance state. However, if the current through the PPTC device increases excessively, and/or the ambient temperature around the PPTC device increases excessively, and/or the normal operating current is maintained for more than the normal operating time, then the PPTC device will be “tripped,” i.e. converted to a high temperature, high resistance state such that the current is reduced substantially. Particularly useful PPTC devices contain a PPTC element which is composed of a PPTC conductive polymer, i.e. a composition which comprises (1) an organic polymer, and (2) dispersed, or otherwise distributed, in the polymer, a particulate conductive filler, such as carbon black. PPTC conductive polymers and devices containing them are described in U.S. Pat. Nos. 4,237,441, 4,238,812, 4,315,237, 4,317,027, 4,426,633, 4,545,926, 4,689,475, 4,724,417, 4,774,024, 4,780,598, 4,800,253, 4,845,838, 4,857,880, 4,859,836, 4,907,340, 4,924,074, 4,935,156, 4,967,176, 5,049,850, 5,089,801 and 5,378,407, the disclosures of which are incorporated herein by reference.

Though they are commonly used with class 2 transformers, circuit breakers and fuses are not automatically resettable and are generally provided as separate components from the transformer. Class 2 transformers therefore tend to be bulky and require labor to be expended in mounting two separate components and the wiring of the components. Class 2 transformers are also expensive, particularly when circuit breakers are used for overcurrent protection. Fuses suffer from the disadvantages discussed in regard to circuit breakers, and must be replaced after an overcurrent or short circuit event. Thus, an unaddressed need exists in the industry.

### SUMMARY

The present invention provides a system and method for a protected transformer system and, more particularly, is related to a system and method for protecting transformers from unsafe current levels using positive temperature coefficient resistive devices. Briefly described, in architecture, the system can be comprised of a transformer and a positive temperature coefficient device. The transformer has a primary and a secondary winding. The secondary winding has a housing, a first terminal, a second terminal, and an insulated covering. The positive temperature coefficient device is connected to the first terminal of the secondary winding. The positive temperature coefficient device is mounted in the housing. The positive temperature coefficient device has a first and second side. The first side of the positive temperature coefficient device is mounted between 0.2 mm and 0.4 mm from the secondary winding. The second side of the positive temperature coefficient device is mounted between 1 mm and 5 mm from the secondary winding. The insulated covering is between the first side of the positive temperature coefficient device and the secondary winding.

Other systems, methods, features, and advantages of the present invention will be, or will become, apparent to one having ordinary skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a simplified functional view of some components of the protected transformer system 100.

FIG. 2 is a simplified center cut-away view of the protected transformer system 100 showing the components shown in FIG. 1 and additional components that may be included in the system 100.

### DETAILED DESCRIPTION

The present invention is generally related to overcurrent protected transformers and, more particularly, is related to a system and method for protecting transformers from unsafe current levels using positive temperature coefficient resistive devices.

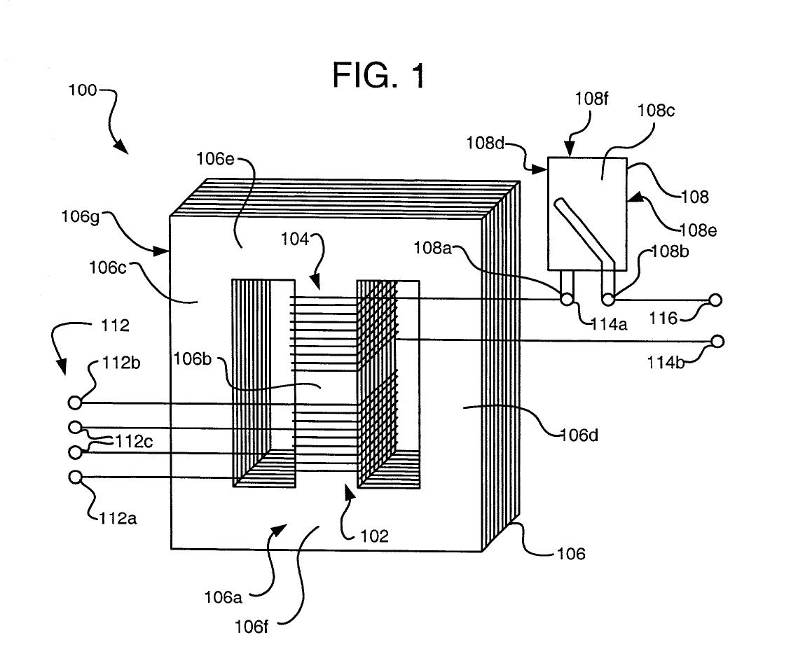

FIG. 1 is a simplified functional view of some components of the protected transformer system 100. FIG. 1 is not intended to show any required structure for the system 100. Instead, FIG. 1 is only intended to provide a functional understanding of the components shown. The protected transformer system 100 comprises a primary winding 102, a secondary winding 104, a laminated core 106, and a positive temperature coefficient device 108. A front side 106a of the laminated core 106 is shown in FIG. 1. The primary winding 102 turns around a bottom portion of a center vertical member 106b of the laminated core 106. The primary winding 102 has a plurality of primary terminals 112. The plurality of primary terminals 112 includes a common terminal 112a, a maximum voltage terminal 112b, and two center tapped terminals 112c. The transformer system 100 is powered via the plurality of primary terminals 112. If the system 100 is being powered via a 480 volt (V) power source, the 480V power source may be connected to the maximum voltage terminal 112b and the common terminal 112a. If the transformer system is being powered via a 230V or 200V power source (not shown), the 230V or 200V power source may be connected to one of the center tapped terminals 112c and the common terminal 112a. Though commonly used voltages are described for the power source, the system 100 is not limited to any particular voltage for the power source.

The secondary winding 104 has a first terminal 114a and a second terminal 114b. The first terminal 114a is shown in FIG. 1 in contact with a first terminal 108a of the positive temperature coefficient device 108. The system 100 may be designed to produce a voltage differential of 24V between the first 114a and second 114b terminals of the secondary winding 104. However, the system 100 is not limited to any particular voltage between first 114a and second 114b terminals.

The laminated core 106 is comprised of low-reluctance magnetic material, such as thin laminated iron sheets. The sheets are coated with an insulating varnish and the sheets are pressed together to form the core 106. Laminated sheets dissipate heat readily and thus provide for the efficient transfer of power from the primary winding 102 to the secondary winding 104. The laminated sheets are formed to include a first vertical side 106c, a second vertical side 106d, the center vertical portion 106a, a top portion 106e, and a bottom portion 106f. A side 106g of the first vertical side 106c of the core 106 is also shown in FIG. 1. Those having ordinary skill in the art are familiar with primary windings, secondary windings, and laminated cores. Primary windings, secondary windings, and laminated cores are commonly provided with power ratings such as, but not limited to, 5 VA to 100 VA.

The positive temperature coefficient device 108 includes the first terminal 108a and a second terminal 108b. The body portion 108c of the device 108 includes a first side 108d, a second side 108e, and a top 108f. The second terminal 108b is in electrical contact with a system terminal 116.

The device 108 has a very low resistance in the normal conductive state and a very high resistance when the device's 108 threshold temperature is exceeded. For example, a device 108 may have less than 0.02 ohm resistance in the normal conductive state and 150 ohm resistance when the threshold temperature is exceeded. Device 108 generally have a rated hold current rating at 20 degrees Celsius(C) ambient temperature and are derated with increases in temperature. The derating may be approximately 50% at 85 degrees C and 60% at 100 degrees C. Device 108 may be a device such as, but not limited to, a polymer positive temperature coefficient (PPTC) device and a ceramic device.

Under normal operations, the current flow through the secondary winding 104 will not generate sufficient ohmic heating to initiate operation of the device 108. However, when the secondary winding 104 is placed in an undesirable operating range, for example an overload, the excess current or excess ambient temperature will initiate operation of the device 108 within a determinable time period. The resistance of the device 108 will dramatically increase, thereby reducing the current in the secondary winding 104 to a minimal value. When the undesirable operating range is caused by a short circuit, the large current in the secondary winding 104 activates the device 108 within milliseconds. After such undesirable operating range conditions have been eliminated, the device 108 will reset to its low resistance state.

The system 100 provides three types of protection: (1) overcurrent/overload protection; (2) short circuit protection; and (3) overheating/thermal cut-off protection. Two devices of particular interest for the protection of NEMA class 2 transformers are the RUE 600 and RUE 700 PPTC devices from Raychem Technologies of Tyco International Ltd. The RUE 600 has a hold current of 6.0 amps at 20 degrees C ambient temperature and a hold current of 3.12 amps at 85 degrees C. The RUE 700 has a hold current of 7.0 amps at 20 degrees C ambient temperature, and a hold current of 3.64 amps at 85 degrees C. Of particular interest for the protection of NEMA class 2 transformers are devices 108 with trip temperatures of between 95 degrees C and 105 degrees C.

The hold current is the highest steady-state current a device will hold for an indefinite period of time without transitioning from the low- to the high-resistance state. The trip current is the current that all similarly designed devices will trip at an ambient temperature. There is some variation among similarly designed devices primarily due to manufacturing variations. The difference between the trip current and the hold current is a region where it is possible the device will either trip or remain in the low-resistance state depending upon the individual device within a class of similarly designed devices.

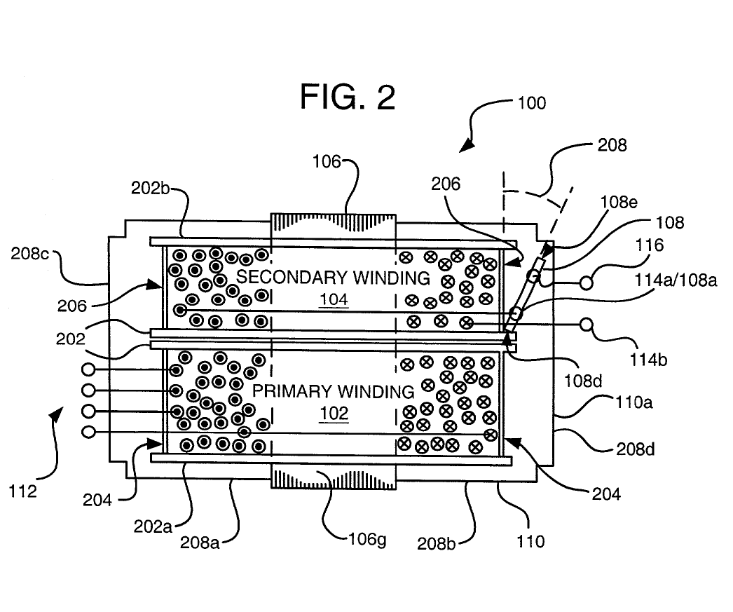

FIG. 2 is a simplified center cut-away view of the protected transformer system 100 showing the components shown in FIG. 1 and additional components that may be included in the system 100. FIG. 2 shows the primary winding 102, the secondary winding 104, the laminated core 106, and the positive temperature coefficient device 108. The side 106g of first vertical side 106c of the laminated core 106 is shown in FIG. 2. The primary winding 102 is supported by a bottom portion 202a of a split bobbin 202. The secondary winding 104 is supported by a top portion 202b of the split bobbin 202. The bobbin 202 is a rigid support platform for the windings 102 and 104 and provides electrical isolation for the windings 102 and 104. The primary winding 102 has an insulation covering 204. The secondary winding 104 has an insulation covering 206. The insulated covering 206 is approximately 0.31 mm thick. The insulated covering 206 may be a class “B” insulating material.

The windings 102 and 104, the bobbin 202, and the positive temperature coefficient device 108 are enclosed by a first housing 208a, a second housing 208b, and the laminated core 106. First 208a and second 208b housings are generally formed of plastic material but may be formed from other materials such as, but not limited to metals. First 208a and second 208b housings may have end-bel coil portions 208c and 208d.

The device 108 is mounted within the second housing 208b. Mounting the device 108 in close proximity to the secondary winding 104 provides thermal protection for the insulated covering 206 of the secondary winding 104. The device 108 is placed in the second housing 208b to provide thermal protection for the secondary winding 104. The exact placement of the device 108 depends upon the material of the insulated covering 206 and the mounting geometry of the device 108. The device 108 is mounted so that the working temperature limit of the device 108 is not exceeded under normal operating conditions. Correct mounting geometries may be determined by testing trip times for the device 108 in comparison to the distance the device 108 is mounted from the secondary winding 104, the type of insulation, the insulation thickness, and the mounting arrangement for the device 108. The mounting arrangement includes a retention system. The retention system may be, but is not limited to, a crimp joint.

The device 108 is shown resting on a flange of the top portion 202b of the bobbin 202. The first side 108d of the device 108 is in contact with the insulated covering 206 of the secondary winding 104. The second side 108e of the device 108 is approximately 3 mm from the insulated covering 206. The device 108 is mounted at an angle 208 from the vertical. The angle 208 may be approximately 30 degrees from the vertical.

It should be emphasized that the above-described embodiments of the present invention, particularly, any “preferred” embodiments, are possible examples of implementations, merely setting forth for a clear understanding of the principles of the invention. Many variations and modifications may be made to the above-described embodiment(s) of the invention without substantially departing from the spirit and principles of the invention. All such modifications are intended to be included herein within the scope of this disclosure and the present invention and protected by the following claims.

At least the following is claimed:

1. A system comprising:
a transformer having a primary and a secondary winding, the secondary winding having a housing, the secondary winding having a first and a second terminal, the secondary winding having an insulated covering; and
a positive temperature coefficient device, the polymer positive temperature coefficient device connected to the first terminal of the secondary winding, the positive temperature coefficient device mounted in the housing, the positive temperature coefficient device having a first and second side, wherein the first side of the positive temperature coefficient device is mounted between 0.2 mm and 0.4 mm from the secondary winding, wherein the second side of the positive temperature coefficient device is mounted between 1 mm and 5 mm from the secondary winding, and wherein the insulated covering is between the first side of the positive temperature coefficient device and the secondary winding.

2. The system of claim 1, where the system is a NEMA class 2 transformer.

3. The system of claim 1, where the voltage rating between the first and second lead of the secondary winding is 24 volts.

4. The system of claim 1, where the transformer is a 75 VA transformer.

5. The system of claim 1, where the housing is plastic.

6. The system of claim 1, where the housing has an end-bell-coil-cover portion and the positive temperature coefficient device is mounted inside the end-bell-coil-cover portion.

7. The system of claim 1, where the insulated covering is generally 0.25 mm thick.

8. The system of claim 1, where the insulated covering is generally a class “B”.

9. The system of claim 1, where the positive temperature coefficient device is a polymer positive temperature coefficient device.

10. The system of claim 1, where the positive temperature coefficient device is a ceramic positive temperature coefficient device.

11. The system of claim 1, where the positive temperature coefficient device is a polymer positive temperature coefficient device with a trip temperature of 95 and 105 degrees Celsius.

12. The system of claim 1, where the positive temperature coefficient device is mounted using a crimp joint.

13. The system of claim 1, where the positive temperature coefficient device is a Raychem RUE device.

14. A system comprising:
a transformer having a primary and a secondary winding, the secondary winding having a housing, the secondary winding having a first and a second terminal, the secondary winding having an insulated covering; and
a positive temperature coefficient device, the polymer positive temperature coefficient device connected to the first terminal of the secondary winding, the positive temperature coefficient device mounted in the housing, wherein the positive temperature coefficient device mounting geometry is based on trip times for the positive temperature coefficient device in comparison to the distance the positive temperature coefficient device is mounted from the secondary winding, the type of insulated covering, the thickness of the insulated covering, and the mounting arrangement for the positive temperature coefficient device.

15. The system of claim 14, where the positive temperature coefficient device is a polymer positive temperature coefficient device.

16. The system of claim 14, where the positive temperature coefficient device is a ceramic positive temperature coefficient device.

17. The system of claim 14, where the positive temperature coefficient device is a polymer positive temperature coefficient device with a trip temperature of 95 and 105 degrees Celsius.

18. The system of claim 14, where the positive temperature coefficient device is mounted using a crimp joint.

19. A system comprising:
a transformer having a primary and a secondary winding, the secondary winding having a housing, the secondary winding having a first and a second terminal, the secondary winding having an insulated covering; and
a means for automatic positive temperature coefficient protection, the means connected to the first terminal of the secondary winding, the means mounted in the housing, wherein the mounting geometry of the means is based on trip times for the means in comparison to the distance the means is mounted from the secondary winding, the type of insulated covering, the thickness of the insulated covering, and the mounting arrangement for the means.

20. The system of claim 19, where the means for positive temperature coefficient protection includes a polymer.

21. The system of claim 19, where the means for positive temperature coefficient protection includes a ceramic.

22. The system of claim 19, where the means for positive temperature coefficient protection has a trip temperature of between 95 and 105 degrees Celsius.

23. The system of claim 19, where the means for positive temperature coefficient protection is mounted using a crimp joint.

24. A method comprising the steps of:
providing a transformer having a primary and a secondary winding, the secondary winding having a housing, the secondary winding having a first and a second terminal, the secondary winding having an insulated covering; and
mounting a positive temperature coefficient device to the first terminal of the secondary winding, where the positive temperature coefficient device is mounted in the housing, where the positive temperature coefficient device mounting geometry is based on trip times for the positive temperature coefficient device in comparison to the distance the positive temperature coefficient device is mounted from the secondary winding, the type of insulated covering, the thickness of the insulated covering, and the mounting arrangement for the positive temperature coefficient device.

25. The method of claim 24, where the positive temperature coefficient device is a polymer positive temperature coefficient device.

26. The method of claim 24, where the positive temperature coefficient device is a ceramic positive temperature coefficient device.

27. The method of claim 24, where the positive temperature coefficient device is a polymer positive temperature coefficient device with a trip temperature of 95 and 105 degrees Celsius.

28. The method of claim 24, where the positive temperature coefficient device is mounted using a crimp joint.
